(19) United States
(12) Patent Application Publication
(10) Pub. No.: US 2013/0188564 A1
(43) Pub. Date: Jul. 25, 2013

(54) RESOURCE ALLOCATION IN AN ORTHOGONAL FREQUENCY DIVISION MULTIPLEXING SYSTEM

(71) Applicants: Derek YU, Kanata (CA); Patrick LIE CHIN CHEONG, Kanata (CA); Roger MAH, Nepean (CA)

(72) Inventors: Derek YU, Kanata (CA); Patrick LIE CHIN CHEONG, Kanata (CA); Roger MAH, Nepean (CA)

(73) Assignee: TELEFONAKTIEBOLAGET L M ERICSSON (PUBL), Stockholm (SE)

(21) Appl. No.: 13/354,652

(22) Filed: Jan. 20, 2012

(51) Int. Cl. H04W 72/08

(52) U.S. Cl. 370/329

(57) ABSTRACT

A scheduler performs per sub-band prioritization allocation of sub-bands to user terminals to generate a pre-allocation schedule. The prioritization is performed independently for each sub-band. The resulting pre-allocation schedule indicates the relative priorities of the user terminals for each sub-band taking into account the channel conditions and specific needs of the user terminals. Based on the pre-allocation schedule, the scheduler can more efficiently allocate the radio resources to the user terminals based on the channel conditions and the specific needs of the user terminals. The scheduling approach is suitable for parallel computing architectures. The use of a parallel computing architecture increases MIPS (million instructions per second) capacity and allows faster scheduling in order to meet stringent real-time constraints.

### TECHNICAL FIELD

The present invention relates generally to the scheduling of user terminals on a shared channel and, more particularly, to allocation of the shared resources among the user terminals in an Orthogonal Frequency Division Multiplexing (OFDM) system.

### BACKGROUND

The Physical Downlink Shared Channel (PDSCH) in Long Term Evolution (LTE) systems is a time and frequency multiplexed channel shared by a plurality of user terminals. User terminals periodically send channel quality indication (CQI) reports to a base station. The CQI reports indicate the instantaneous channel conditions as seen by the receivers in the user terminals. During each 1 ms subframe interval, commonly referred to in the standard as a Transmission Time Interval (TTI), a scheduler at the base station schedules one or more user terminals to receive data on the PDSCH and determines the transmission format for downlink transmissions. The identity of the user terminals scheduled to receive data in a given time interval, and the transmission format, is transmitted to the user terminals on the Physical Downlink Control Channel (PDCCH).

LTE systems use Orthogonal Frequency-Division Multiplexing (OFDM), and schedule user terminals in both time and frequency domains. Thus, the scheduler needs to determine the appropriate time (sub-frames) and frequency (sub-bands) to allocate to a given user in order to satisfy the user QoS (Quality of Service) requirements, while at the same time maximizing the possible cell capacity and coverage. The common approach to scheduling of a shared channel in both time and frequency attempts to share the available PDSCH resource blocks (RBs) equally among the user terminals to be scheduled in a given sub-frame. Each sub-band in the frequency domain corresponds to one or more contiguous RBs. Scheduling is performed in an iterative manner. During each iteration, RBs are allocated to each user and link adaptation is performed. If any RBs are unused, subsequent iterations are performed to re-allocate the unused RBs to other user terminals.

During the first iteration, the number of RBs that can be allocated to each user is capped. The cap level is determined by dividing the number of available RBs by the number of user terminals to be scheduled. The scheduler begins by allocating up to the maximum number of RBs to each user in order beginning with the highest priority user. In general, the scheduler will allocate to each user the best available RBs based on the channel conditions reported by the user. Link adaptation is performed at the end of each iteration. The scheduler determines the modulation and coding scheme (MCS) for each user based on the number of RBs allocated to the user, the amount of buffered data for the user, and the channel quality associated with the sub-bands allocated to the user. If a user does not need all of its allocated RBs, the scheduling process is repeated and the unused RBs are re-allocated to other user terminals in subsequent iterations. This process repeats until all RBs have been allocated or there is no more data to schedule.

The scheduling process used in the prior art has a number of disadvantages. First, the amount of resources that can be allocated to each user is blindly capped without regard to the actual needs of the user terminals. Second, the allocation of resources to user terminals in order of scheduling priority does not result in the most efficient use of the resources. For example, a resource that is better used by a lower priority user may be assigned to a higher priority user. Therefore, the resource will not be available to the lower priority user when his/her turn for scheduling arrives. Also, the blind cap on resources may cause a resource best used by a higher priority user to be allocated to a lower priority user. Third, the scheduling algorithm is executed sequentially in real-time. Due to the increasingly large number of wireless user terminals being added to the system, it is becoming more difficult to perform sequential scheduling while meeting the stringent time constraints for making scheduling decisions.

### SUMMARY

The present invention provides methods and apparatus for scheduling user terminals in an OFDM system. The scheduling approach implemented by embodiments of the present invention attempts to maximize system capacity while meeting QoS requirements for the user terminals. To perform more efficient scheduling, a per sub-band prioritization is performed before allocation of the sub-bands to the user terminals to generate a pre-allocation schedule. The prioritization is performed independently for each sub-band. The resulting pre-allocation schedule indicates the relative priorities of the user terminals for each sub-band taking into account the channel conditions and specific needs of the user terminals. Based on the pre-allocation schedule, the scheduler can more efficiently allocate the radio resources to the user terminals based on the channel conditions and the specific needs of the user terminals. This scheduling approach is suitable for parallel computing architectures. The use of a parallel computing architecture increases MIPS (million instructions per second) capacity and allows faster scheduling in order to meet stringent real-time constraints.

Exemplary embodiments of the invention comprise methods for scheduling user terminals in an OFDM system. In one exemplary method, the scheduler independently determines a scheduling weight for each user terminal for each of a plurality of sub-bands as a function of a corresponding channel quality weight for the sub-band and service quality weight for the user terminal. Based on the scheduling weights, the scheduler assigns scheduling priorities to the user terminals based on the per sub-band scheduling weights and determines a pre-allocation schedule for each sub-band based on the assigned scheduling priorities. The scheduler then allocates sub-bands to the user terminals based on the sub-band pre-allocation schedule.

Other embodiments of the invention comprise a base station for communicating with a plurality of user terminals over a shared downlink or uplink channel. In one exemplary embodiment, the base station comprises a transceiver circuit for communicating with the mobile terminals and a scheduler, which may comprise one or more scheduling processors, to schedule transmissions to or from the user terminals. The scheduler is configured to determine, for each of a plurality of sub-bands, a scheduling weight for each user terminal as a function of the channel quality metric for the corresponding sub-band and service quality metric for the user terminal. The scheduler is further configured to determine scheduling priority for the user terminals based on the scheduling weights. The scheduling priorities indicate the priority level of each user terminal on each sub-band of interest. The scheduler generates a pre-allocation schedule for each sub-band based on the scheduling priorities of the user terminals and allocates the sub-bands to the user terminals based on the pre-allocation schedule.

The scheduling approach as herein described provides optimal scheduling in a given scheduling interval based on the scheduling weight, resulting in more efficient use of system resources and greater system capacity. The processing intensive operations can be performed in parallel resulting in more efficient hardware utilization and increased scheduling speed. The parallel processes can be extended across multiple sectors within a cell site utilizing a common pool of digital signal processors.

### BRIEF DESCRIPTION OF THE DRAWINGS

FIG. 1 illustrates an exemplary communication network according to one embodiment.

FIG. 2 illustrates a time-frequency grid for uplink and downlink communications.

FIG. 3 illustrates an exemplary base station according to an exemplary embodiment.

FIG. 4 illustrates an exemplary scheduler for scheduling transmissions to or from user terminals.

FIG. 5 illustrates an exemplary scheduling method.

FIG. 6 illustrates an exemplary method of updating scheduling weights used in the scheduling method of FIG. 5

FIG. 7 illustrates an example allocation procedure used in the scheduling method of FIG. 5

FIG. 8 illustrates an exemplary set of scheduling weights for four user terminals in five sub-bands.

FIG. 9 illustrates an exemplary sub-band pre-allocation schedule.

FIG. 10 illustrates a bitmap representation of a sub-band pre-allocation schedule.

### DETAILED DESCRIPTION

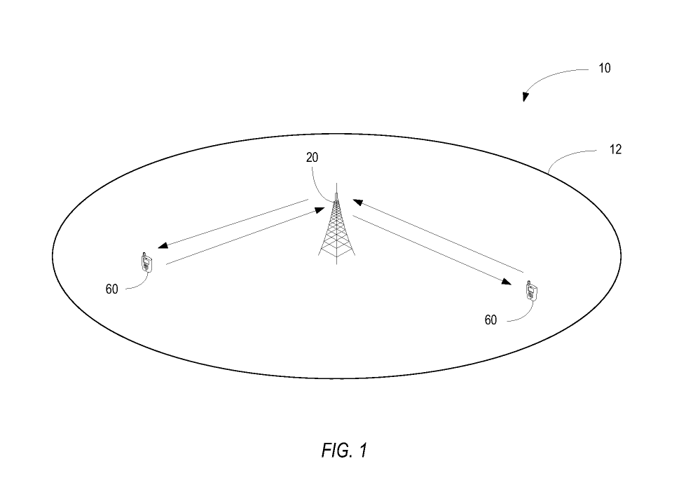

Turning now to the drawings, FIG. 1 illustrates an exemplary communication network 10 according to one exemplary embodiment of the present invention. The communication network 10 comprises a plurality of cells 12, though only one cell 12 is shown in FIG. 1. A base station 20 within each cell 12 communicates with the user terminals 60 within the cell 12. The base station 20 transmits data to the user terminals 60 over a downlink channel for downlink communications, and receives data from the user terminals 60 over an uplink channel for uplink communications.

For illustrative purposes, an exemplary embodiment of the present invention will be described in the context of a Long Term Evolution (LTE) system. Those skilled in the art will appreciate, however, that the present invention is more generally applicable to other wireless communication systems, such as WiMAX (IEEE 802.16) systems, where scheduling of frequency resources is performed.

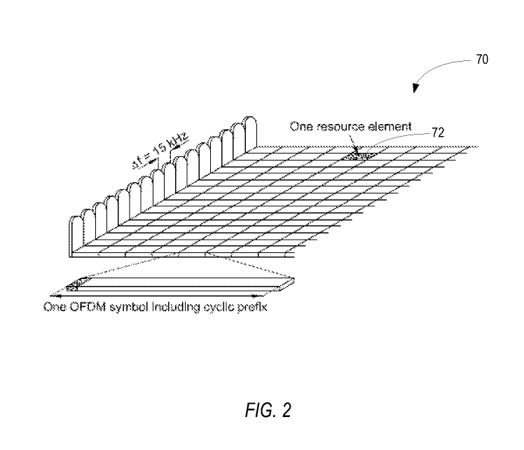

LTE uses Orthogonal Frequency Division Multiplexing (OFDM) in the downlink and Discrete Fourier Transform (DFT) spread OFDM in the uplink. The available radio resources in LTE systems can be viewed as a time-frequency grid. FIG. 2 illustrates a portion of an exemplary OFDM time-frequency grid 70 for LTE. Generally speaking, the time-frequency grid 70 is divided into one millisecond subframes. Each subframe includes a number of OFDM symbols. For a normal cyclic prefix (CP) length, suitable for use in situations where multipath dispersion is not expected to be extremely severe, a subframe comprises fourteen OFDM symbols. A subframe comprises twelve OFDM symbols if an extended cyclic prefix is used. In the frequency domain, the physical resources are divided into adjacent subcarriers with a spacing of 15 kHz. The number of subcarriers varies according to the allocated system bandwidth. The smallest element of the time-frequency grid 70 is a resource element 72. A resource element 72 comprises one OFDM subcarrier during one OFDM symbol interval.

In LTE systems, data is transmitted to the user terminals 60 over a downlink transport channel known as the Physical Downlink Shared Channel (PDSCH). The PDSCH is a time and frequency multiplexed channel shared by a plurality of user terminals 60. During each 1 ms subframe interval, commonly referred to as a Transmission Time Interval (TTI), a scheduler for the base station 20 schedules one or more user terminals 60 to receive data on the PDSCH. The user terminals 60 scheduled to receive data in a given TTI are chosen based on Channel Quality Indication (CQI) reports from the user terminals 60. The CQI reports indicate the instantaneous channel conditions as seen by a receiver at the user terminals 60. As described in more detail below, the CQI reports may report CQI separately for different sub-bands. The base station 20 also uses the CQI reports from the user terminals 60 and the buffer status for the user terminals 60 to select the transmission format for downlink transmissions. The transmission format includes, for example, the transport block size, modulation, and coding, which are selected to achieve a desired error performance.

In LTE and other OFDM systems, user terminals 60 are scheduled in both time and frequency domains. The available resources are grouped into resource blocks (RBs). A RB comprises twelve adjacent subcarriers in the frequency domain, and one 0.5 ms slot (one half of one subframe) in the time domain. In the frequency domain, the RBs are grouped into sub-bands. Each sub-band comprises one or more contiguous RBs. User terminals 60 are scheduled in 1 ms intervals, which is equal to two resource blocks (one subframe) in the time domain. To schedule the user terminals 60, the scheduler 50 needs to determine the appropriate time (sub-frames) and frequency (sub-bands) to allocate a given user in order to satisfy user QoS (Quality of Service) requirements and at the same time maximize the possible cell capacity and coverage.

In general, the scheduler 50 determines which user terminals 60 to schedule in a given TTI, i.e., sub-frame. Then the scheduler 50 allocates the resources blocks for the sub-frame to the scheduled user terminals. In general, it is desirable to allocate the RBs in a sub-band to the user terminal 60 with the best channel conditions, subject to service quality requirements. Allocating resources to user terminals 60 with the best channel conditions allows higher data rates to be achieved, and hence greater system capacity.

In exemplary embodiments of the invention, each user terminal 60 being scheduled is assigned a scheduling weight for each sub-band based on the channel quality reported by the user terminal 60 for that sub-band and the quality of service requirements for the user terminal 60. The user terminals 60 may then be prioritized separately for each sub-band. Per sub-band prioritization enables more optimal scheduling to achieve greater system capacity. Additionally, per sub-band prioritization is well-suited for parallel processing architectures.

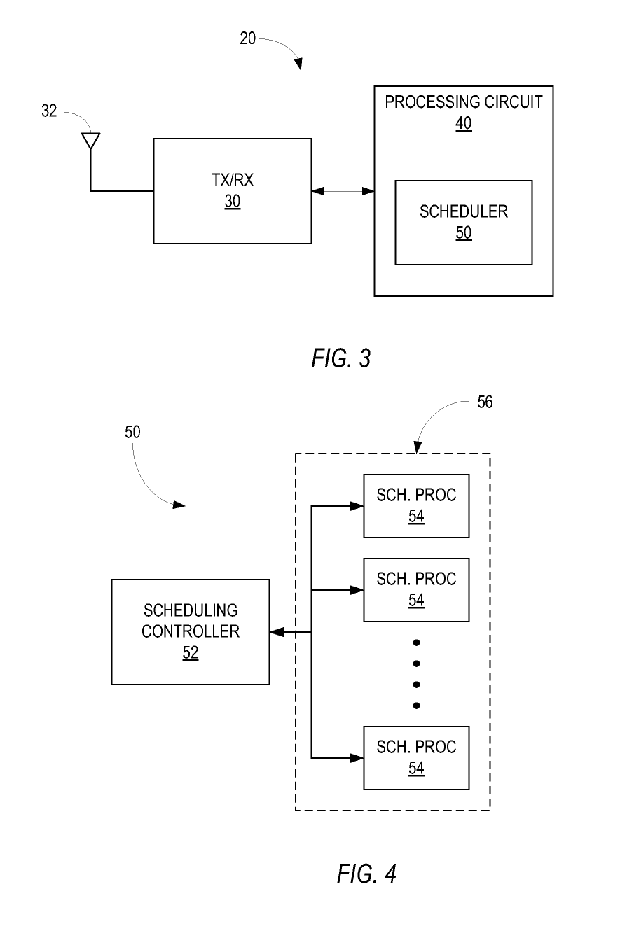

FIG. 3 illustrates an exemplary base station 20 according to one exemplary embodiment. Base station 20 comprises a transceiver 30 coupled to an antenna 32, a processing circuit 40, and a scheduler 50, which may comprise a part of the processing circuit 40. Transceiver 30 comprises a standard cellular transceiver operating according to any known standard using OFDM, such as the LTE, and WiMAX standards. Processing circuit 40 processes signals transmitted and received by the transceiver 30. Typical processing functions performed by the processing circuit 40 include modulation/demodulation, channel coding/decoding, interleaving/de-interleaving, etc. The processing circuit 40 may comprise one or more processors, microcontrollers, hardware circuits, or a combination thereof. Instructions executed by the processing circuit 40 may be stored in a computer readable medium, such as solid state memory (e.g., ROM, Flash memory, etc.). As note above, the processing circuit 40 may include a scheduler 50 to schedule downlink and/or uplink transmissions between the base station 20 and the user terminals 60 in the cell served by the base station 20.

FIG. 4 illustrates the main functional components of the scheduler 50 in more detail. The scheduler 50 comprises a scheduling controller 52 and a plurality of scheduling processors 54 in a processor pool 56. The scheduling controller 52 contains the main scheduling logic and can assign processing tasks to different scheduling processors 54. The scheduling processors 54 within the processing pool 56 may be shared among multiple base station 20. As shown in FIG. 4, the scheduling processors 54 may be arranged in a parallel processing architecture.

In some embodiments, the scheduler 50 may be co-located with the transceiver 30 and perform scheduling for a single cell. In other embodiments, the scheduler 50 may located remotely from the transceiver 30 and perform scheduling for multiple cells.

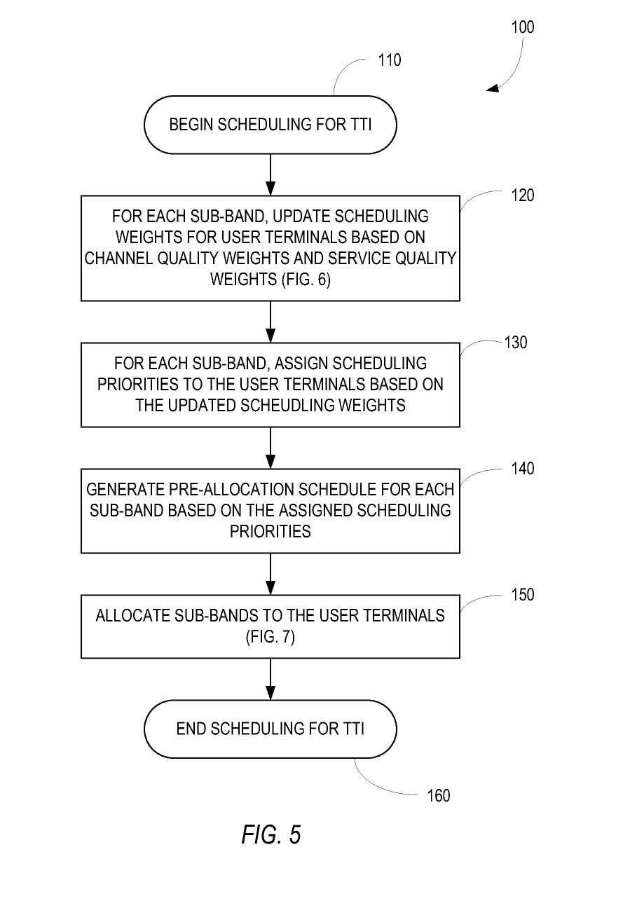

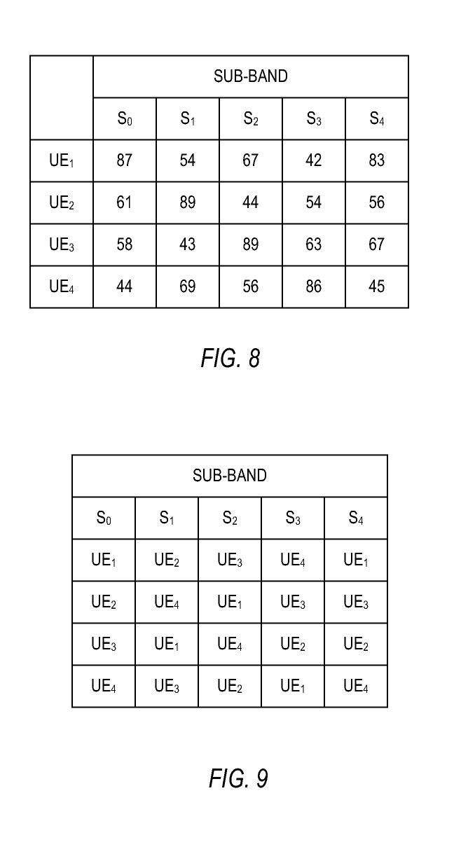

FIG. 5 illustrates an exemplary scheduling procedure 100 implemented by the scheduler 50 for allocating OFDM resources. The scheduling procedure is triggered at a periodic scheduling interval, i.e. TTI. (block 110). In LTE, a TTI is 1 ms, which corresponds to one sub-frame in the OFDM time-frequency grid. The scheduler 50 initially updates the scheduling weights for the user terminals 60 for each available sub-band (block 120). As previously noted, the scheduling weights for the user terminals 60 are computed separately for each sub-band. FIG. 8 illustrates computed scheduling weights for four user terminals 60, denoted as UE1-UE4, for five sub-bands, denoted as S0-S4.

The task of computing the scheduling weights may be assigned by the scheduling controller 52 to different scheduling processors 54. In one exemplary embodiment, the scheduling controller 52 assigns each user terminal 60 to a different scheduling processor 54 to compute scheduling weights. In this case, each scheduling processor 54 computes the scheduling weights for an assigned user terminal 60 for all sub-bands. In other embodiments, the scheduling controller 52 may assign each sub-band to a scheduling processor 54 to compute the scheduling weights for the sub-band. In this case, each scheduling processor 54 is assigned to compute scheduling weights for all user terminals 60 for an assigned sub-band.

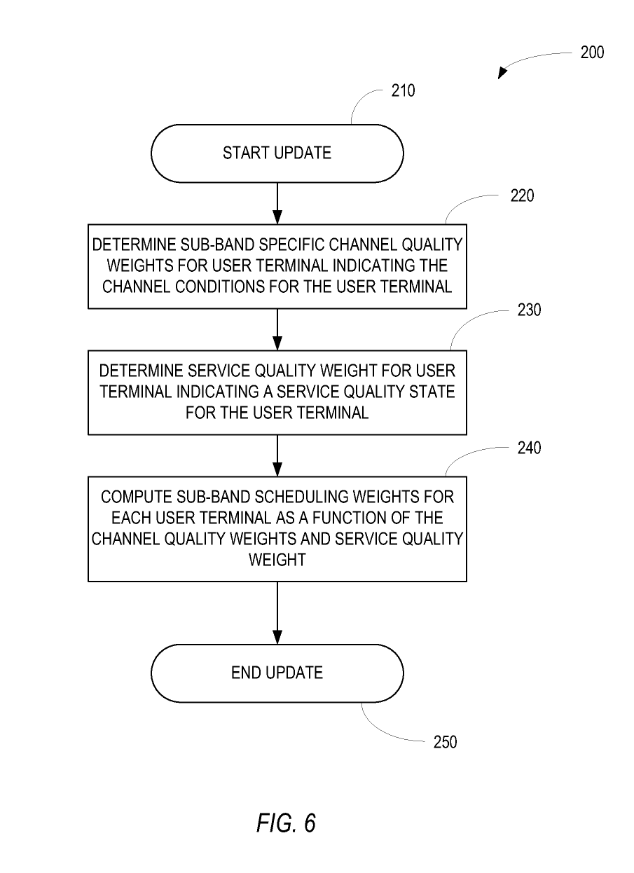

FIG. 6 illustrates an exemplary update procedure 200 for updating the scheduling weights. When the update procedure is triggered (block 210), the scheduling controller 52 determines the sub-band specific channel quality weights for each user terminal 60 (block 220). For each user terminal 60, the channel quality of a specific sub-band will vary over time. The channel quality may vary independently for each sub-band. Therefore, the scheduler 50 may periodically request a channel quality indication (CQI) report from the user terminals 60. The CQI report contains the channel quality measured by the user terminal 60 for each sub-band of interest. The report is processed and each sub-band channel quality weight is updated to reflect the current channel condition for the user terminal 60. Details of CQI reports can be found in Section 7.2 of the LTE 3GPP standard document TS 36.213, “Technical Specification: Physical Layer Procedures (Release 8).” This specification provides the sub-band channel condition update procedure to facilitate scheduling in the frequency domain. The frequency of the CQI reports may vary between user terminals 60 depending on how fast the channel is changing for the user terminals 60. Typically, the frequency of the CQI reports is much slower than the scheduling interval. Therefore, the processing of the CQI reports can be performed in the background as a separate process.

In some embodiments of the invention, a service quality weight is computed for each user terminal 60 (block 230). The service quality weight is a reflection of the service quality state of a given user terminal 60 and indicates how well the user terminal 60 is being served based on its (QoS) requirements. A user terminal 60 that is being underserved according to its QoS requirements will be given a higher service quality weight than a user terminal 60 whose QoS requirements are met. Assigning higher weights to underserved user terminals 60 increases the probability that the user terminal 60 will be scheduled in the next scheduling interval.

The scheduling weights are computed as a function of both the sub-band specific channel quality weights and service quality weights (block 240). The computation of the scheduling weight, denoted W_{SB} is given by:

W_{SB}=W_{QoS}+W_{CQ,SB} (0.1)

where W_{CQ,SB} is the sub-band specific channel quality weight and W_{Qos} is the service quality weight, which is the same for all sub-bands. The sub-band specific channel quality weight W_{CQ,SB} is related to a data rate that can be supported within the sub-band. The larger the weight, the larger the data rate that can be supported. The service quality weight W_{Qos} indicates how urgent the need is to schedule the user terminal 60 in order to meet its QoS requirements. The update procedure 200 is then completed (block 250).

Returning to FIG. 5, once the scheduling weights are updated, the scheduling controller 52 assigns scheduling priorities to the user terminals 60 for each sub-band (block 130). The scheduling priorities are determined based on the computed scheduling weights. User terminals 60 with higher scheduling weights are given higher priority for the sub-band. Thus, using the scheduling weights of FIG. 8 as an example, for sub-band S0, the order of priority is UE1 (87), UE2 (61), UE3 (58), and UE4 (44).

The task of computing the sub-band priorities may be assigned by the scheduling controller 52 to different scheduling processors 54. In one exemplary embodiment, each scheduling processor 54 is assigned to compute the user terminal priorities for an assigned sub-band. Thus, the user terminal priorities for each sub-band can be computed in parallel. In other embodiments, the scheduling controller 52 or one of the scheduling processors 54 may compute the scheduling priorities for all of the sub-bands.

Once the scheduling priorities are determined, the scheduling controller 52 generates a consolidated pre-allocation schedule for all of the sub-bands of interest (block 140). FIG. 9 illustrates an exemplary pre-allocation schedule based on the scheduling weights in FIG. 8. The columns of the table in FIG. 9 correspond to sub-bands and the rows correspond to priority levels. In this example, the order of priority from highest to lowest for sub-band S0 is UE1, UE2, UE3, and UE4.

In some embodiments, the scheduling controller 52 consolidates the sub-band prioritizations performed by the individual scheduling processors 54 to generate the pre-allocation schedule. In other embodiments, the scheduling controller 52, or one of the scheduling processors 54, may simultaneously prioritize the user terminals 60 and generate the pre-allocation schedule.

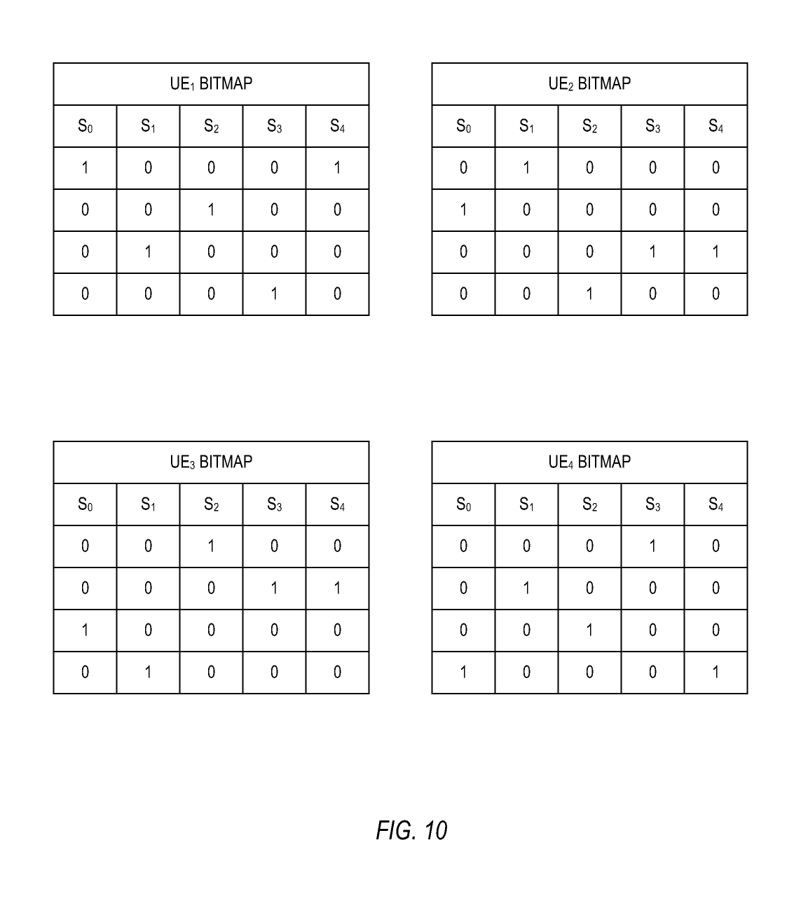

FIG. 10 illustrates a bitmap representation of the pre-allocation schedule. Each bitmap corresponds to one of the user terminals 60. The columns of the bitmap correspond to sub-bands and the rows correspond to priority levels. A “1” indicates the priority of the user terminal for a given sub-band. In the example shown in FIG. 10, UE1 has first priority for sub-bands S0 and S4, second priority for sub-band S2, third priority for sub-band S1, and fourth priority for sub-band S3. The bitmap representation of the pre-allocation schedule conserves storage requirements, and bitmap manipulations using bitwise logical operations also save execution cycles.

Referring again to FIG. 5, after the pre-allocation schedule is generated, the scheduler 50 allocates the sub-bands to the user terminals 60 based on the pre-allocation schedule (block 150). Because the pre-allocated sub-bands for each user terminal 60 are known and are independent for each user terminal 60, the allocation of sub-bands can be performed simultaneously by different scheduling processors 54. The scheduling controller 52 may assign each user terminal 60 to a scheduling processor 54 to perform allocation for the designated sub-bands. Scheduling for the TTI is then completed (block 160).

The scheduler 50 is configured to iteratively allocate the sub-bands to the user terminals 60 in order of the sub-band specific priorities beginning with the user terminals having the highest sub-band specific priority in each sub-band. A user terminal 60 may be pre-allocated multiple sub-bands. In such case, the sub-bands pre-allocated to the user terminal 60 are allocated in the order of best to worst as measured by the scheduling weights. If a user terminal 60 does not require all of the pre-allocated sub-bands, the unused sub-bands can be redistributed to other user terminals 60 in subsequent iterations.

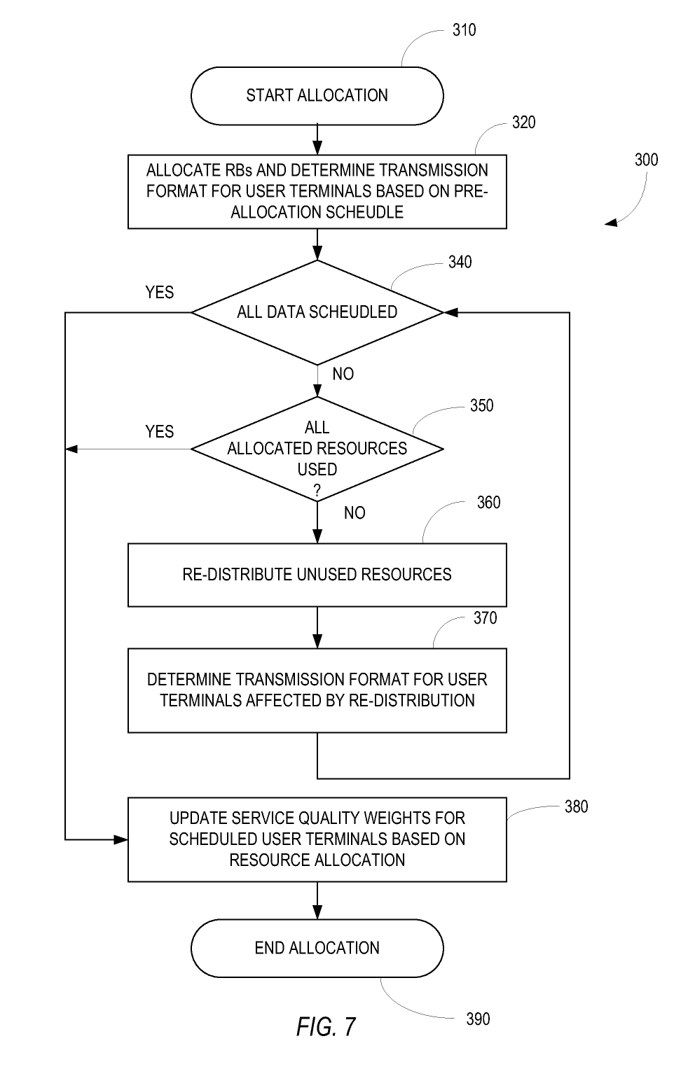

FIG. 7 illustrates an exemplary method 300 for performing resource allocation. The allocation process begins after the generation of the pre-allocation schedule (block 310). The resource allocation step is performed iteratively based on the pre-allocation schedule. During the first iteration, the sub-bands are allocated as specified by the first row of the pre-allocation schedule and the transmission formats are determined based on the allocation (block 320). In the example shown in FIGS. 8 and 9, sub-bands S0 and S4 are allocated to UE1, sub-band S1 is allocated to UE2, sub-band S2 is allocated to UE3, and sub-band S3 is allocated to UE4. The scheduler 50 determines the transmission formats, e.g. modulation and coding scheme (MCS), for the user terminals 60 based on the channel quality associated with the allocated sub-bands and the buffer status. This step, commonly referred to as link adaptation, may be performed simultaneously for each user terminal 60. The scheduling controller 52 may assign each user terminal 60 to a scheduling processor 54 to perform the link adaptation step.

Because buffer status is not considered in the pre-allocation schedule, a user terminal 60 may not use all of the resources, i.e. sub-bands, that it was allocated in the pre-allocation schedule. Therefore, after link adaptation is completed for the first iteration, the scheduling controller 52 determines whether all data has been scheduled (block 340) and, if not, whether there are any unused resources remaining (block 350). If so, a second scheduling iteration is performed to redistribute the unused resources (block 360). Thus, a sub-band pre-allocated to a user terminal 60 having insufficient data to use the pre-allocated sub-band may be redistributed to a second user terminal 60 having data in excess of the capacity of its pre-allocated sub-bands. After re-allocation of the unused resources, the transmission format is determined for the user terminals 60 affected by the re-allocation (block 370). This re-allocation process repeats until all resources are assigned or until all buffered data has been scheduled. Once all resources have been assigned and the transmission format determined for all user terminals, the scheduler 50 updates the service quality weights for the user terminals 60, which are used in the next scheduling interval to determine the scheduling weights for the user terminals 60 (block 380). The computation of the service quality weights can be performed simultaneously for all user terminals 60 by different scheduling processors 54. The resource allocation process ends (block 390) after the service quality weights are updated.

By considering the buffer status of the user terminals 60 in advance, it is possible to reduce the number of scheduling iterations in certain situations. In the example of FIGS. 8 and 9, assume that UE1 has very limited buffered data and that UE2-UE4 have full buffers. In the normal iterative operations, the unused sub-band (either S0 or S4) would either be allocated to UE2 or UE3 in the second iteration and the whole process requires two iterations. Specifically, if UE1 selected S0, S4 would be allocated to UE3. If it selected S4, then S0 would be allocated to UE2. However, by performing a pre-allocation of UE1's sub-band with two additional Link Adaptations (one for UE2 and one for UE3) in the same iteration, all sub-band allocations to all UEs can be consolidated and finalized in a single iteration. This is achieved at the cost of a single redundant Link Adaptation. In fact, in this example, the redundant Link Adaptation can be avoided as the scheduler 50 already knows which is the better sub-band between S0 and S4 for UE1. The remaining one can be re-assigned right away.

The scheduling approach as herein described provides optimal scheduling in a given scheduling interval based on the scheduling weight, resulting in more efficient use of system resources and greater system capacity. The processing intensive operations can be performed in parallel resulting in more efficient hardware utilization and increased scheduling speed. The parallel processes can be extended across multiple sectors within a cell site utilizing a common pool of digital signal processors. Although the exemplary embodiment as described is used for scheduling downlink transmission, the techniques as described herein may also be applied to schedule uplink transmissions.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of scheduling wireless transmissions to or from a plurality of wireless terminals, said method comprising:
for each of a plurality of sub-bands, determining a scheduling weight for each user terminal as a function of channel quality metrics indicative of channel conditions for the user terminals for each of said sub-bands and service quality metrics indicative of a service quality state for the user terminals;
for each of said plurality of sub-bands, assigning sub-band specific scheduling priorities to the user terminals indicating the respective priorities of said user terminals;
generating a sub-band pre-allocation schedule based on the sub-band specific scheduling priorities; and
allocating sub-bands to the user terminals in accordance with the sub-band pre-allocation schedule.

2. The method of claim 1 wherein allocating sub-bands to the user terminals based on the sub-band pre-allocation schedule comprises allocating sub-bands to the user terminals using two or more parallel processors to perform the allocation for different sub-bands.

3. The method of claim 2 wherein allocating sub-bands to the user terminals using two or more parallel processors further comprises assigning separate processors in a common pool of processors to allocate different sub-bands to the user terminals.

4. The method of claim 1 wherein assigning scheduling priorities to said user terminals for a sub-band based on the scheduling weights comprises assigning higher priority to user terminals with higher scheduling weights.

5. The method of claim 1 further comprising calculating scheduling weights in parallel for two or more user terminals using two or more parallel processors.

6. The method of claim 5 wherein calculating scheduling weights in parallel for two or more user terminals further comprises assigning separate processors in a common pool of processors to calculate scheduling weights for each user terminal.

7. The method of claim 1 further comprising determining transmission formats for the user terminals using two or more parallel processors.

8. The method of claim 7 wherein determining transmission formats for the user terminals using two or more parallel processors comprises assigning separate processors in a common pool of processors to determine transmission formats for each user terminal.

9. The method of claim 1 wherein allocating sub-bands to the user terminals in accordance with the sub-band pre-allocation schedule comprises iteratively allocating the sub-bands to the user terminals in order of the sub-band specific priorities beginning with the user terminals having the highest sub-band specific priority in each sub-band.

10. The method of claim 9 wherein the sub-bands pre-allocated to the same user terminal are allocated to the user terminal in order of the scheduling weights.

11. The method of claim 10 further comprising redistributing a pre-allocated sub-band from a first user terminal having insufficient data to use the pre-allocated sub-band to a second user terminal having data in excess of the capacity of its pre-allocated sub-bands.

12. The method of claim 11 wherein the redistribution is performed in a second iteration.

13. The method of claim 11 wherein the redistribution is performed during said first iteration.

14. The method of claim 1 wherein determining a scheduling weight for each user terminal is based on sub-band specific channel quality weights for the user terminal.

15. A base station in a wireless communication network comprising:
a transceiver for communicating with a plurality of user terminals over a wireless communication channel; and
a scheduler comprising one or more scheduling processors for scheduling transmissions to or from the user terminals, said scheduling processor being configured to:
for each of a plurality of sub-bands, determine a scheduling weight for each user terminal as a function of channel quality metrics indicative of channel qualities for the user terminals and service quality metrics indicative of service quality states for the user terminals;
for each of said plurality of sub-bands, assigning sub-band specific scheduling priorities to the user terminals indicating the respective priorities of said user terminals;
determine a sub-band pre-allocation schedule based on the scheduling priorities; and
allocating sub-bands to the user terminals in accordance with the sub-band pre-allocation schedule.

16. The base station of claim 15 wherein the scheduler is configured to allocate sub-bands to the user terminals using two or more parallel processors to perform the allocation for different sub-bands.

17. The base station of claim 16 wherein the scheduler is configured to assign separate processors in a pool of processors to allocate different sub-bands to the user terminals.

18. The base station of claim 15 wherein the scheduler is configured to assign higher priority to user terminals with higher scheduling weights.

19. The base station of claim 15 wherein the scheduler is further configured to calculate the scheduling weights in parallel for two or more user terminals using two or more parallel processors.

20. The base station of claim 19 wherein the scheduler is configured to assign separate processors in a common pool of processors to calculate scheduling weights for each user terminal.

21. The base station of claim 15 wherein the scheduler is further configured to determine transmission formats for the user terminals using two or more parallel processors.

22. The base station of claim 21 wherein the scheduler is configured to iteratively allocate the sub-bands to the user terminals in order of the sub-band specific priorities beginning with the user terminals having the highest sub-band specific priority in each sub-band.

23. The base station of claim 22 wherein the scheduler is configured to allocate the sub-bands pre-allocated to the same user terminal in order of the scheduling weights

24. The base station of claim 15 wherein the scheduler is further configured to allocate sub-bands during a first iteration to the user terminals based on the sub-band specific priorities.

25. The base station of claim 24 wherein the scheduler is further configured to redistribute a pre-allocated sub-band from a first user terminal having insufficient data to use the pre-allocated sub-band to a second user terminal having data in excess of the capacity of its pre-allocated sub-bands.

26. The base station of claim 25 wherein scheduler is configured to perform the redistribution in a second iteration.

27. The base station of claim 25 wherein scheduler is configured to perform the redistribution during said first iteration.

28. The base station of claim 15 wherein the scheduler is configured to calculate the scheduling weights based on sub-band specific channel quality weights for the user terminals.
